(19) United States
(12) Patent Application Publication
(10) Pub. No.: US 2024/0004065 A1
(43) Pub. Date: Jan. 4, 2024

(54) GHZ CMOS ULTRASONIC IMAGER PIXEL ARCHITECTURE

(71) Applicant: Geegah LLC, Ithaca, NY (US)

(72) Inventors: Amit Lal, Ithaca, NY (US); Justin Kuo, Ithaca, NY (US); Ivan Bukreyev, Gaithersburg, MD (US)

(73) Assignee: Geegah LLC, Ithaca, NY (US)

(21) Appl. No.: 18/039,117

(22) PCT Filed: Dec. 22, 2020
(86) PCT No.: PCT/US2020/066648

§ 371 Date: May 26, 2023

(51) Int. Cl. G01S 15/89; G01S 7/52

(52) U.S. Cl. CPC G01S 15/899; G01S 7/5202; G01S 7/52026; G01S 7/52085; G01S 7/52096

(57) ABSTRACT

An GHz ultrasonic transducer pixel, alone or incorporated into imaging system with a CMOS device. The ultrasonic transducer pixel includes an ultrasonic transducer connected to a transmit circuit and a receive circuit. The transmit and receive circuits are chosen by switches. The ultrasonic transducer pixel also includes a mixer of the receive circuit positioned as a first stage in the receive circuit, a pixel select circuit comprising analog components and digital components, and a power supply conditioning circuitry.

### GOVERNMENT FUNDING

This invention was made with government support under Award No. 1746710 awarded by the National Science Foundation (NSF) and Award No. AR0001049 by the Advanced Research Projects Agency—Energy. The government has certain rights in the invention.

### BACKGROUND OF THE INVENTION

### 1. Field of the Invention

The present invention generally relates to pixel circuitry and, more particularly, to a GHz ultrasonic transducer pixel.

### 2. Description of Related Art

Recent work (PCT/US20/35537 assigned to the assignee hereof and incorporated herein by reference) has demonstrated the concept of sending short ultrasonic pulses through a silicon wafer to realize an oscillator. Planar thin-film piezoelectric transducers are used to transmit and receive the pulses. The transit time between the transmit and receive transducers is proven to be stable over time owing to low loss of ultrasonic energy in high-quality crystals. For the very same reason resonators made of high-quality materials are used to achieve high-quality factor, the pulse-transmit of ultrasonic pulses results in stable time-of-flight. Once the time-of-flight has been stabilized, the stable delay can be used to form an oscillator.

The reflected signal is also affected by the impedance of any material contacting the back side of the silicon chip. The reflected signal amplitude and phase can be affected by the reflection coefficient. This measurement can be used to image the material touching the backside of the chip. This capability has been shown before (U.S. Pat. No. 10,217,045 B2) for imaging fingerprints. Because the wave pulses can be reflected multiple times from the top side of the wafer, by measuring the pulse packet reflected once from the backside, reflected from the front side, and then reflected from the backside, the ultrasonic impedance on the object on the front side of the chip can also be measured. The objects in contact with the front side of the chips also affect the transmitted pulse. In backside imaging modality, the front side of the chips is isolated from the work via packaging. However, the effect of the front side loading and reflections from the front surface can also be used to image the objects in contact with the chip on the front of the chip.

The piezoelectric transducers are fabricated on top of a CMOS wafer or can be built on planar silicon and non-silicon substrates. Integration with CMOS wafers offers the pathway to integrate clocks and oscillators directly into circuits, eliminating the need for an external resonator structure employed in current systems. One can also use a separate CMOS electronics chip and a separate ultrasonic pulse-transit chips allows one to optimize the pulse-transit chips and the CMOS circuits independently of each other, to provide different oscillators with combinations of CMOS chips and US transmit/receive chips.

The transmitted ultrasonic pulse undergoes diffraction, given that the aperture of the transducer is of finite width. Diffraction results in the distribution of the pulses in different angles from the transmitters. Owing to the different angles, the pulses travel along different lengths through the substrates, as they reflect off the backside of the substrate, to arrive at the receiver. For example, the pulses associated with the first order and second order diffraction peaks can result in two times of arrivals on the receive transducer. This concept was demonstrated recently and has produced a stable delay element with ˜1-ppm stability. In a related work, this delay line is placed in an electronic oscillator and has resulted in an oscillator with 1-5 ppm stability.

Therefore, there is a need for a GHz ultrasonic transducer pixel integrated with a CMOS device that can measure both the amplitude and phase of ultrasonic waves.

### BRIEF SUMMARY OF THE INVENTION

The invention described herein is GHz ultrasonic transducer pixel, alone or incorporated into imaging system with a CMOS device.

Embodiments of the present invention are directed to a GHz ultrasonic transducer pixel and an imaging system. According to one aspect, the ultrasonic transducer pixel includes an ultrasonic transducer connected to a transmit circuit and a receive circuit. The transmit and receive circuits are chosen by switches. The ultrasonic transducer pixel also includes a mixer of the receive circuit positioned as a first stage in the receive circuit, a pixel select circuit comprising analog components and digital components, and a power supply conditioning circuitry.

According to another aspect, the imaging system includes a CMOS device comprising one or more CMOS circuits, one or more piezoelectric transducers attached to the CMOS device, and one or more pixels connected to the one or more piezoelectric transducers. Each pixel of the one or more pixels has a transmit circuit and a receive circuit and each receive circuit comprises a mixer first.

These and other aspects of the invention will be apparent from and elucidated with reference to the embodiment(s) described hereinafter.

### BRIEF DESCRIPTION OF THE SEVERAL VIEWS OF THE DRAWING(S)

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments. Reference is now made briefly to the accompanying drawings, in which:

FIG. 1 is a simplified schematic representation of the pixel circuitry of a GHz ultrasonic transducer pixel;

FIG. 2 is a schematic representation of a circuit using the analog output line wiring parasitics as a sample and hold using the output select switch in a pixel as a sampling switch;

FIG. 3 is a detailed schematic representation of an implemented pixel circuit (power rail decoupling capacitors not shown);

FIG. 4A is a micrograph of implemented 50 μm by 50 μm pixel. The CMOS circuit is underneath the pixel transducer is therefore not visible

FIG. 4B is a CAD layout of the pixel circuitry;

FIG. 5 is a pixel output for 1.89 GHz ultrasound measured from a 1×16 test array;

FIG. 6A is a diagrammatic representation of epoxy-backed reference pixel versus a sensing pixel that is not covered by epoxy;

FIG. 6B is a schematic representation of subtraction of reference pixel output from sensing pixel output using differential amplifier;

FIG. 6C is a diagrammatic representation of the signal difference that is to be amplified;

FIG. 7A is a schematic representation of a typical IQ demodulator;

FIG. 7B is a simplified schematic representation of an implementation of a single mixer demodulator in a GHz ultrasonic pixel;

FIG. 8 is a schematic representation of a LO switching scheme;

FIG. 9A is a diagrammatic representation of voltage on a transducer, showing how the transmit pulse and the receive echo are separated in time;

FIG. 9B is a diagrammatic representation of how the I and Q signals are acquired using LO switching;

FIG. 10 is a graph showing time multiplexed IQ received signals for the first echo for a single pixel in the 128×128 pixel array chip at 1.867 GHz;

FIG. 11 is a graph applying the internal sample and hold to time-multiplexed IQ demodulation;

FIG. 12A is a conventional configuration of phased array in biomedical imaging for transmit-side beamforming shown for an example 5×5 array;

FIG. 12B is a phased array where the beam is focused for maximum response near a single pixel of interest;

FIG. 13A is a phased array when only a single phase shifter is available for the array and the pixels are transmitted with the desired phase one pixel at a time and the receive signal is stored and summed up over all of the transmit phases;

FIG. 13B is a phased array when a phase shifter is available per row in the array and the pixels can be transmitted with the desired phases one column at a time;

FIG. 14A is a simplified block diagram of array chip using a single ADC for the entire array;

FIG. 14B is a diagrammatic representation of amplification of the difference between the pixel output voltage and a reference voltage from a DAC to increase the signal amplitude;

FIG. 15 is a simplified block diagram illustrating how the array can be implemented such that an entire column of pixels is read from at a time;

FIG. 16 is a block diagram illustrating how the ADC and amplifier can be shared between multiple columns using analog switches, if the sizes of the amplifier and/or ADC: are larger than the array pixel pitch.

FIG. 17A is a schematic representation of a pixel receive circuit with a storage capacitor to perform sample and hold of the received signal;

FIG. 17B is a schematic representation of a buffer amplifier used after the storage capacitor to relax the specifications required for row peripheral amplifiers, at the cost of pixel area;

FIG. 18A is a schematic representation of an ADC located within a single pixel;

FIG. 18B is a schematic representation of a pixel-level ADC shared between several pixels; and

FIG. 18C is a schematic representation of an exemplary implementation of a pixel-level ADC using a single-slope ADC.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

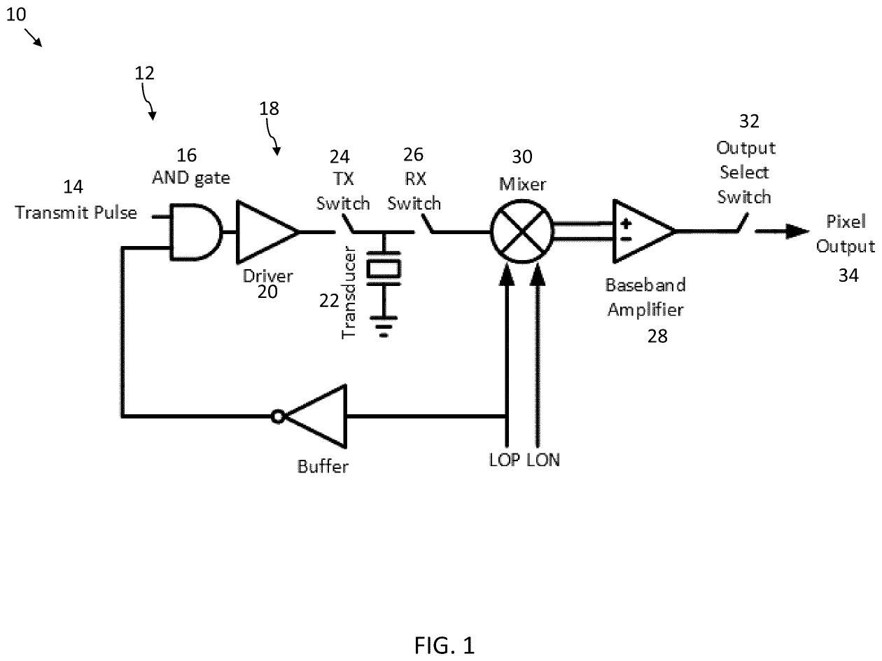

Referring now to the figures, wherein like reference numerals refer to like parts throughout, FIG. 1 is a simplified schematic representation of a pixel circuitry 10 for a GHz ultrasonic transducer pixel. For a GHz ultrasonic transducer pixel, it is important to fit all the transmit and receive circuit underneath the area of a transducer to achieve the highest SNR (signal-to-noise ratio) and to achieve the highest pixel density and array size possible by eliminating the need to fan out wiring from the transducers in an array. The depicted embodiment of the pixel circuitry 10 has been tested up to 2.4 GHz. Further, the transistors and the metal wiring for the pixel transmit and receive circuits do not block the ultrasound from passing through the CMOS stack. The primary challenge in implementing the pixel circuitry 10 for the GHz ultrasonic transducer is in fitting the necessary transmit and receive circuitry within the area of the pixel, while keeping the power consumption of the circuit low. The pixel circuitry 10 shown in FIG. 1 fits within the area of the pixel.

As shown, a transmit circuit 12 is used to generate the RF pulse 14 used to drive the transducer by gating the LO signal. An AND gate 16 is shown in the embodiment depicted in FIG. 1, but a switch can also be used to achieve the same purpose. This gating circuit 12 is followed by a driver circuit 18, which can be implemented using a CMOS inverter 20, which is sized appropriately to drive the impedance of the transducer 22. Switches 24, 26 are used to connect the transducer 22 to the transmit or receive circuits during the transmit and receive phases, respectively, because the acoustic echoes are delayed from the transmit pulse, there is a window of time during when the transmit (TX) switch 24 can be opened and the receive (RX) switch 26 connected so that the transducer 22 does not get driven by the transmitter during receiving the acoustic echoes and so that the receive amplifier 28 does not get saturated by the transmit pulse when transmitting.

Previous implementations of the transducer receive circuit, both on the PCB level using COTS (commercial off-the-shelf) components and on the CMOS level, have used a RF amplifier as the first stage—both conventional voltage amplifiers and transimpedance amplifiers can be used. A primary challenge with designing RF amplifiers is that to achieve high gain in GHz frequencies, the size of the amplifier must be increased, which not only makes fitting the receive circuit under a transducer more difficult, but also increases both the power consumption of the amplifier, as well as the input capacitance of the amplifier. For small transducers, not only is the receive echo lower in amplitude (compared to larger transducers) due to increased diffraction, the capacitive division between the electrical capacitance of the transducer and the input capacitance of the amplifier can cause a reduction in receive signal amplitude, because the transducer capacitance reduces as the size of the transducer decreases.

Therefore, as shown in FIG. 1, a direct conversion mixer-first style architecture is used. Therefore, instead of an amplifier being used as the first receiver stage, a mixer 30 is used in the depicted embodiment, a passive mixer 30 is used as the first stage. A passive mixer 30, such as that described in US20170366138A1, comprises transistor switches that gate the input signal at the local oscillator frequency. A passive mixer topology is used in modern radios to implement mixer first architectures. A main advantage of the passive mixer is small area consumption. Furthermore, by scaling the transistors where the ½CV² power is minimized, relatively low power consumption operation can be achieved. Furthermore, the dynamic range can be higher as the limits on keeping active transistor biased in the right regime are not critical. In contrast, an active mixer using biased multipliers, that multiply the local oscillator frequency and the input signal. The active mixer works with poorer performance and larger area consumption and which also requires an additional bias voltage, and additional power consumption. Note, the transducer 22 itself works as a RF filter so that only the frequencies at which ultrasound is present are received.

There are several primary motivations behind this approach. The first is so that amplification on the signal is achieved in the baseband. This allows for much smaller and lower power amplifiers to be used, while still achieving the same gains, allowing higher gain amplifiers to be fit within the area of a pixel, while also achieving smaller input capacitances on those amplifiers. The second motivation is that the mixer impedance does not load the transducer as much, resulting in higher overall signals compared with implementations in which an amplifier is used as the first stage. The third motivation is that overall power consumption is reduced because the amplifiers no longer need to work at GHz frequencies, but instead at the much lower baseband frequency. An ancillary motivation is that the LO frequency can be increased further and is no longer limited by the frequency response of the receive amplifier, which is considerably more difficult to design for a high bandwidth, while still achieving gain, compared with a passive mixer. Instead for the circuit described, the bandwidth is primarily limited by the capabilities of the transmit driver to drive the transducer at high frequency and the capability of the LO distribution network to distribute a high frequency LO to the pixels.

Still referring to FIG. 1, mixers typically must be followed by a filter to filter out higher order mixing products, requiring large capacitors. To reduce pixel area, the filter for the pixel mixer 30 is realized by the frequency response of the baseband amplifier 28 combined with the parasitics from the pixel output selection switches 32 and the routing capacitance from the wiring used to route the pixel output 34 out of the array.

The baseband amplifier 28 is implemented by a commonly utilized complementary self-biased differential amplifier. This type of inverter-based amplifier 28 achieves high gain within a small area, and most importantly, does not require a current source bias, reducing the amount of bias lines that need to be distributed through the chip. The bias for the amplifier inputs comes through the mixers 30, which are biased on the pixel side through a resistor. This allows for easy control of the amplifier input bias, which is important since this type of amplifier can be vulnerable to process variation due to the high gain.

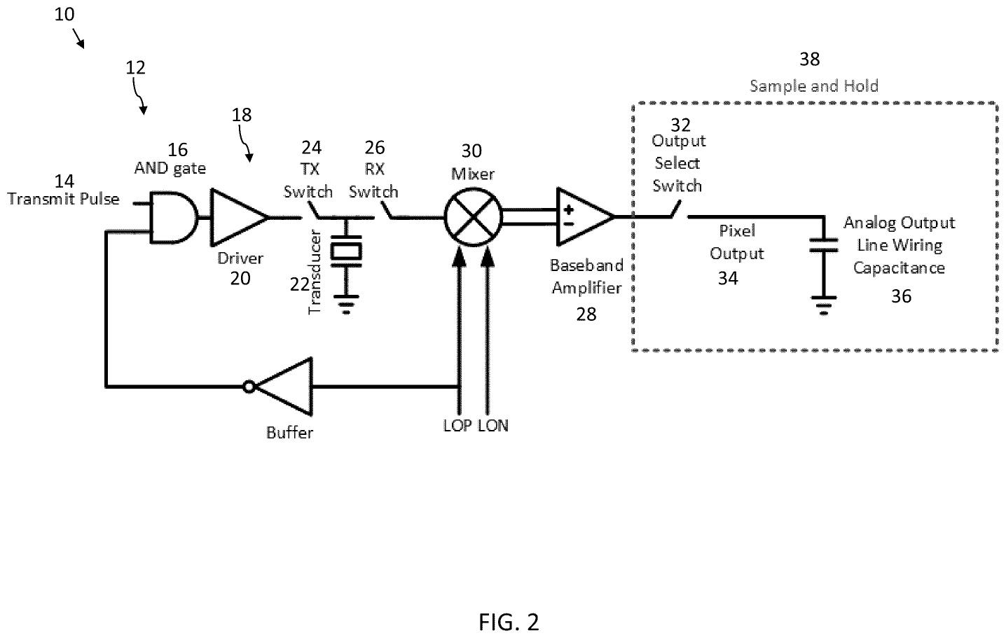

Turning now to FIG. 2, there is shown a more complete schematic for a pixel that was implemented in 130 nm CMOS technology. Specifically, FIG. 2 shows a schematic representation of a circuit 10 using the analog output line wiring parasitics 36 as a sample and hold using the output select switch 32 in a pixel as a sampling switch.

Still referring to FIG. 2, the baseband amplifier 28 is followed by a switch 32 that is used to connect the output of the amplifier 28 to the output line 36 and output selection multiplexers used to select the output 34 of the active pixel of the array and route that output 34 out of the array. Because the wiring capacitance of the output line 36, which is shared among multiple pixels, can be quite large, this output selection switch 32 can also be used to implement a sample and hold 38 to reduce ADC (analog-to-digital converter) speed requirement, as shown in FIG. 2.

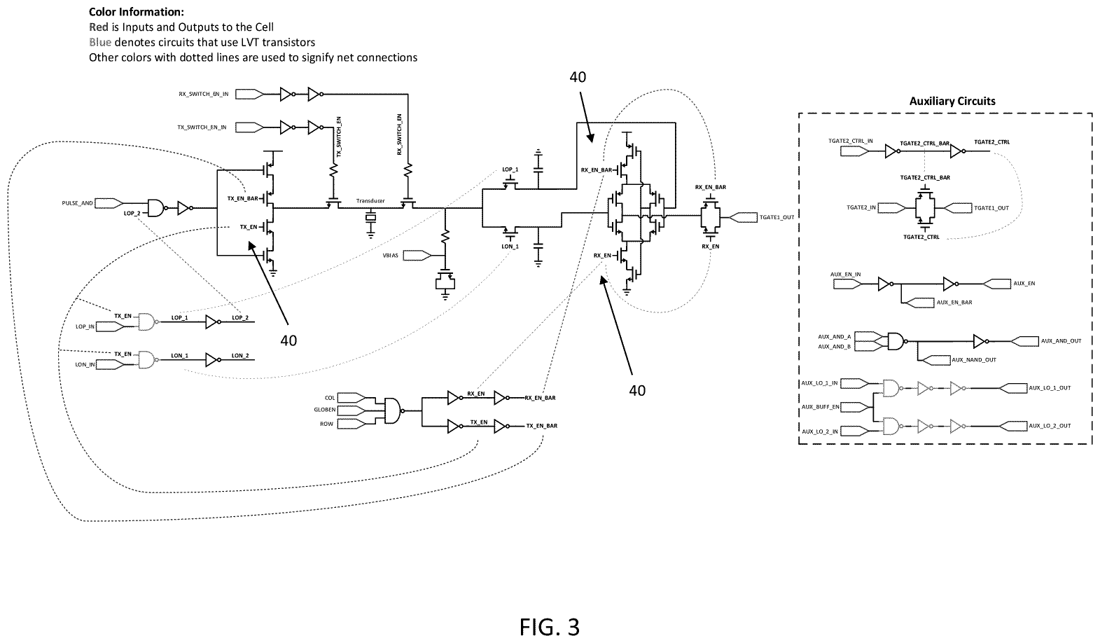

Referring now to FIG. 3, there is shown a more detailed schematic of the pixel circuitry. Specifically, FIG. 3 shows a detailed schematic representation of implemented pixel circuit without power rail decoupling capacitors shown. In FIG. 3, it is shown that a control signal can be used to turn on and off the transmit and receive circuits within a pixel (see disable switches 40). This is important because if all the pixels in a large array were to turn on at the same time, the circuit can suffer failure due to the large power required to turn on all the pixels. FIG. 3 also shows that, in addition to the main transmit and receive circuits, there are a set of auxiliary circuits comprised of digital buffers, LO buffers, switches, and gates. These are used to form some of the additional row logic and output selection circuits, as well as used to insert clock buffers where necessary in the global array, and can also be used as spare cells.

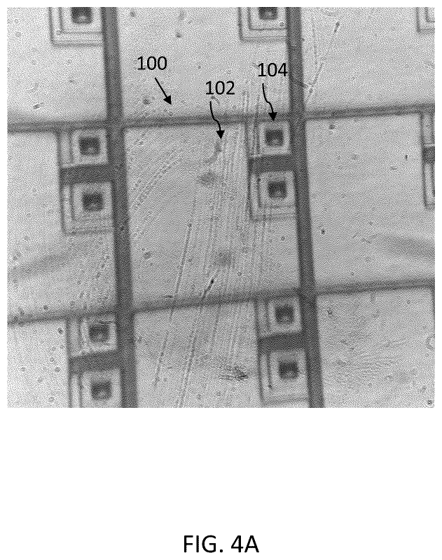

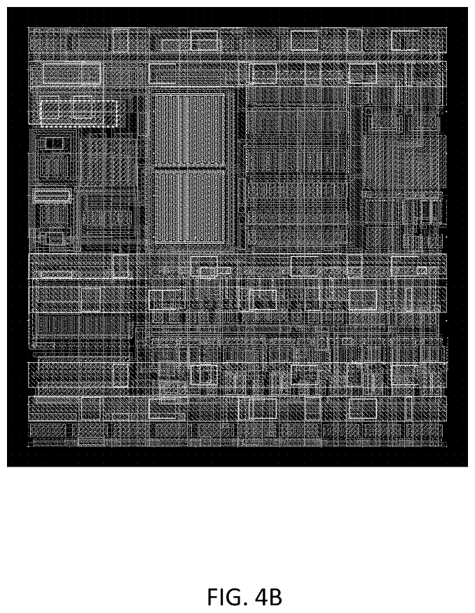

Turning now to FIGS. 4A and 4B, there is shown the layout of an implemented version of the pixel 100, as well as micrograph of the fabricated pixel 100, Specifically, FIG. 4A shows a micrograph of implemented 50 μm by 50 μm pixel 100. The CMOS circuit is located beneath the pixel transducer and therefore is not visible in the micrograph. FIG. 4B shows the CAD layout of the pixel circuitry. The pixel transducer 102 is drawn so that the area is maximized, to reduce diffraction and to increase received signal. Therefore, the transducer 102 covers all but one corner 104 of the pixel 100 (shown in FIG. 4A), which is allocated for the via to the top transducer electrode and the via to the bottom transducer electrode. The transducer's two electrodes can be connected in the reverse order with the top electrode being connected to ground, and the bottom connected to the drive circuit.

The pixel layout is designed so that all the space that is not used by the pixel circuit is used for decoupling the bias lines and the power supply, as well as to improve substrate grounding. In addition, the wiring required for global routing of digital control signals, bias lines, and power distribution is designed directly into the pixel and the metal density requirement design rules are also satisfied on the pixel level layout.

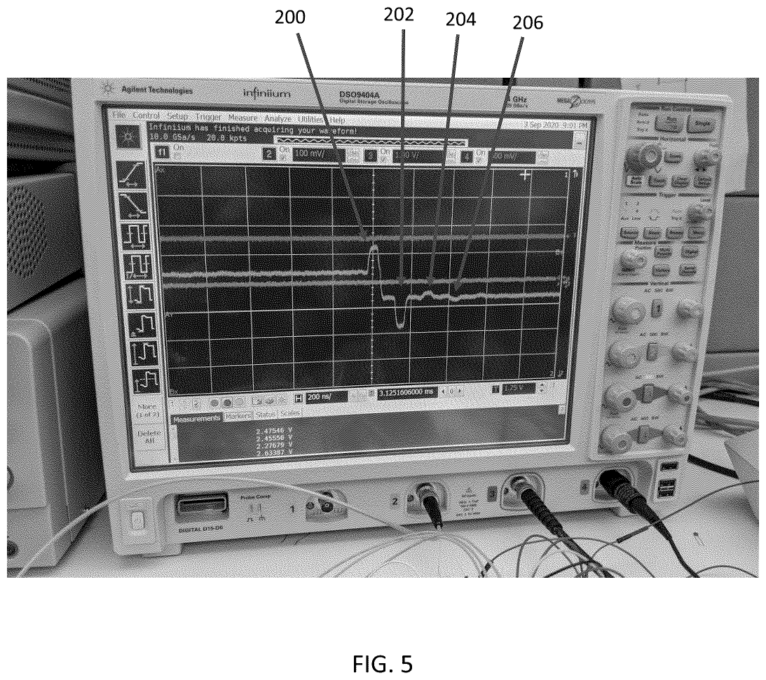

Turning now to FIG. 5, there is shown a pixel output for 1.89 ultrasound, measured from a 1×16 test array. This circuit has been successfully implemented in a 130 nm technology to realize a 1×16 array and a 128×128 array. The pixel output from the 1×16 array is shown in FIG. 5, where the acoustic echoes (first echo 202, second echo 204, and third echo 206) and the transmit coupling 200 are shown. The primary signal of interest is typically the first acoustic echo 202. The amplitude of the first echo 202 is large (50-100 mV) compared to previous non-CMOS integrated transducers, which must be driven with 5V amplitude signals to achieve >10 mV amplitudes for the first echo. The signal is amplified further to achieve high bit resolution when measured with an ADC (analog-to-digital converter).

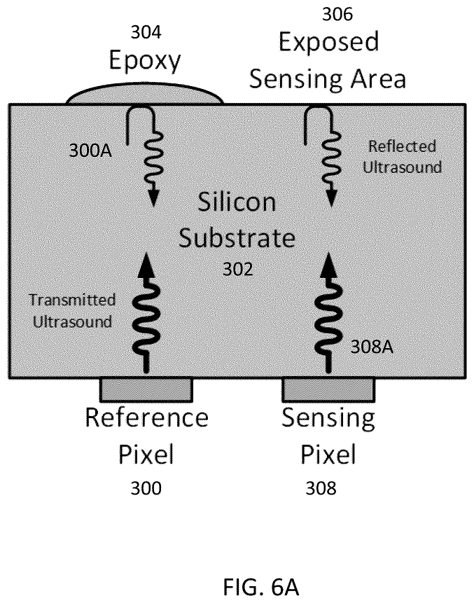

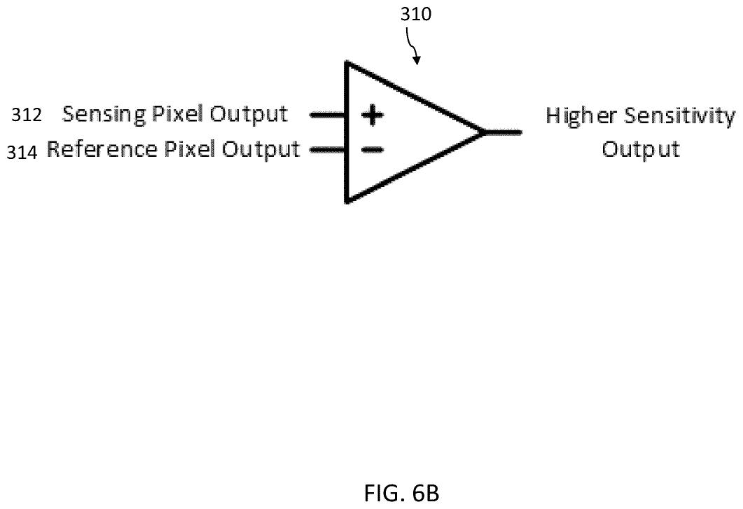

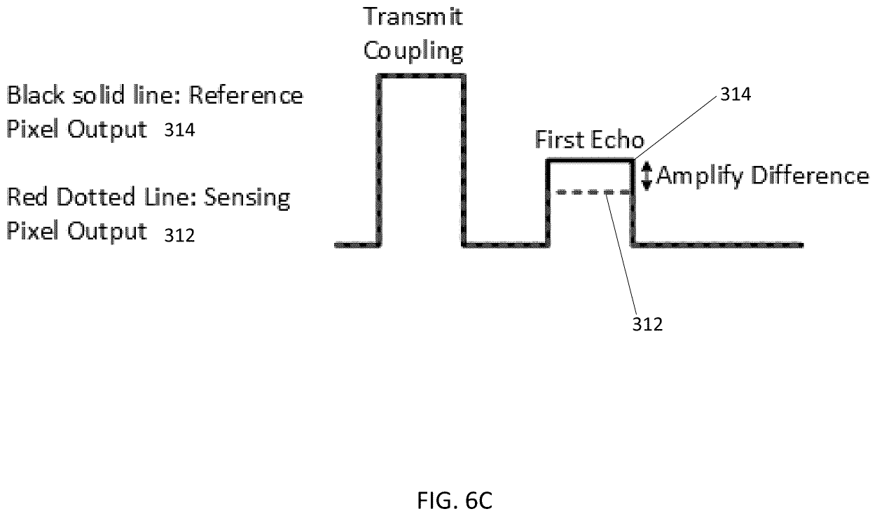

Referring now to FIG. 6A-6C, there are shown various diagrammatic and schematic representations of the use of a reference pixel 300 for increasing sensitivity in amplitude only measurements. A proposed method to amplify the signal as described above is to use a reference pixel 300, coated on the silicon backside 302 with epoxy (or some other acoustic absorber material or material stack) 304 so that the sensing surface 306 on the silicon backside 302 is inert, and use the received signal 300A as a voltage reference to differentially amplify with, as shown in FIG. 6A. The sensing array pixels 308 do not have epoxy on the silicon backside 302 so their signal 308A will change depending on the material that the sensor is sensing. The reference pixel can be placed on the edge of the chip, where the object being imaged does not come in proximity to the imager focal plane array. In another local control, a second pixel can accompany every actual image pixel as a reference pixel. This second approach may lead to reduced imager pixel density. A differential amplifier 310 (FIG. 611) can be used to amplify the difference between a sensing pixel output 312 and the reference pixel output 314 (or the difference between the reference pixel output 314 and the sensing pixel output 312 depending on the desired signal polarity, as shown in FIG. 6C), allowing the sensitivity of the sensor to be increased.

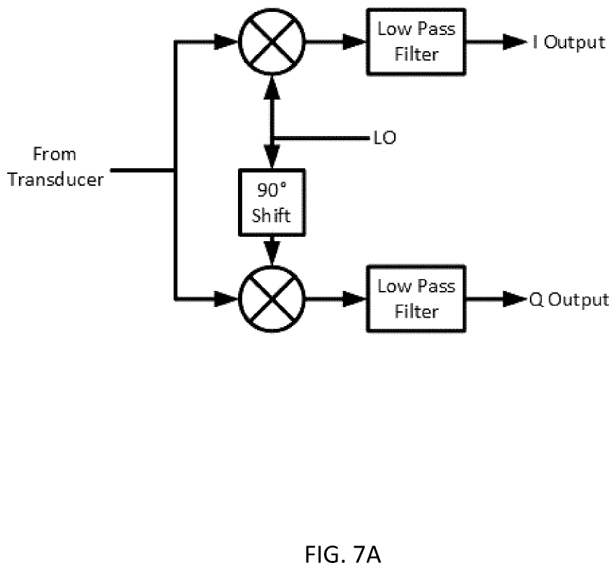

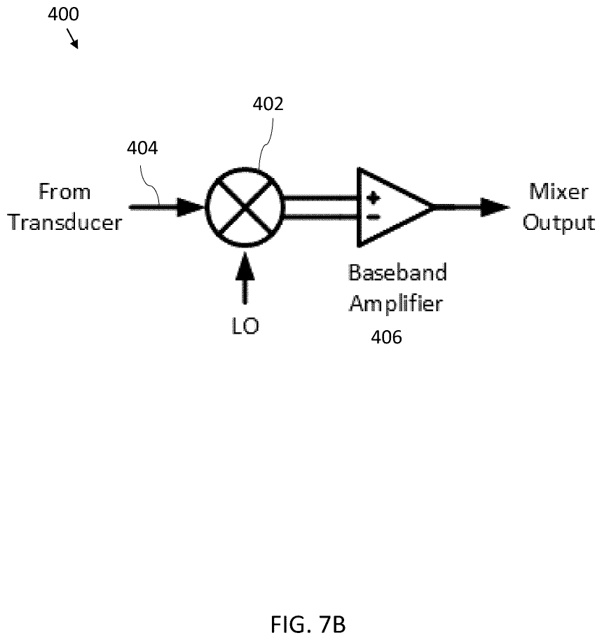

It is desirable to perform IQ demodulation (also called quadrature demodulation) on the received ultrasonic signal to obtain both amplitude and phase data. The primary difficulty faced in implementing a quadrature demodulator within a pixel is that it consumes a lot more circuit area than when just a single mixer is used. This is because, not only are there two mixers, there must also be two amplifiers to amplify and buffer each of the mixer outputs, as shown in FIG. 7A, as well as double the number of switches and multiplexers used to route the outputs out of each pixel and to select the outputs of the active pixels.

Therefore, in order to minimize circuit area, the topology of the pixel 400 described herein only uses a single mixer 402 within the receive signal path 404, as shown in FIG. 7B. Note that the amplifier 406 also serves a dual-purpose as a base-band filter due to the frequency response of the amplifier 406.

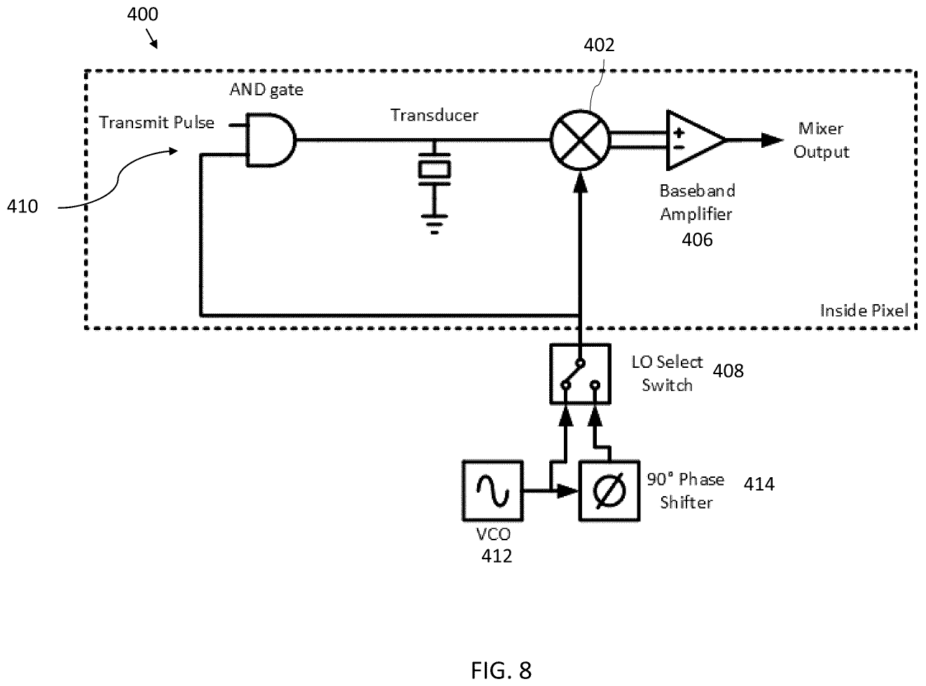

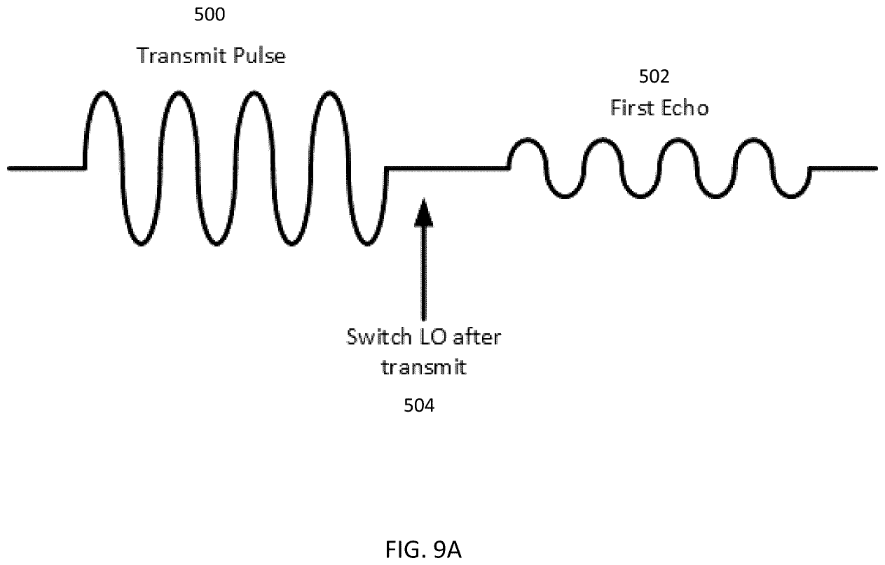

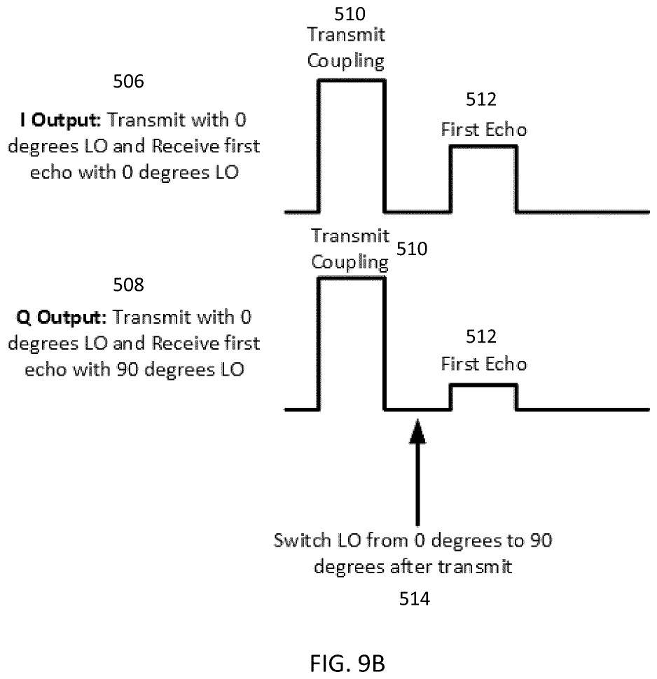

For most sensing applications for the GHz ultrasonic imager, such as for fingerprint imaging or soil imaging, the speed at which the object to be imaged is relatively slow, moving at speeds of <100 Hz, compared to the imaging speed of the sensor. Furthermore, due to the nature of ultrasonic imaging, the acoustic echo is delayed from the transmitted pulse by tens of nanoseconds to over a hundred nanoseconds. Therefore, we propose a scheme in which the quadrature output is obtained in a “time-multiplexed” fashion, where the I output is measured first, then the Q output is measured afterwards, using a switch 408 to switch the LO phase during after the second transmit, as shown in FIGS. 8 and 9.

Turning to FIG. 8, the method to implement this LO switching scheme is shown. Within each pixel 400, the transmit circuit 410 and the receive mixer 402 are fed with the same LO (signal buffers for isolation are not shown for simplicity). Outside of the pixel 400, the source for the LO is from a VCO 412. A 90 degrees phase shifter 414 is used to provide a 90 degrees phase shifted version of the LO signal for quadrature demodulation. A fast switching select RF switch 408 is used to select between the un-shifted LO and the 90-degrees-shifted LO. This switch 408 can be implemented either with typical RF switch topologies or with digital gates if integrated on-chip.

Referring now to FIGS. 9A-9B, the timing at which the LO is to be shifted can be seen. For example, as shown in FIG. 9A, for 725 um thick silicon, the first echo 502 (from the reflection of the ultrasonic wave at the back-side silicon sensing interface) is delayed approximately 170 ns from the start of the transmit pulse 500, Depending on the pulse width of the transmit pulse 500 (typically 50-100 ns wide), there is a window of tens of nanoseconds of time in which the mixer LO can be switched 504. First, the I Output 506 is acquired without any LO switching a 0 degrees LO is applied during the transmit 510 and the first echo receive phase 512. After the Output signal 506 is acquired, a second transmit-receive cycle 510, 512 is performed for the pixel to acquire the Q Output 508. The transmit pulse is still transmitted with the 0 degrees LO, but right after transmitting, the LO is switched to 90 degrees LO 514, so that the first echo 512 can be demodulated with 90 degrees LO to acquire the Q Output 508.

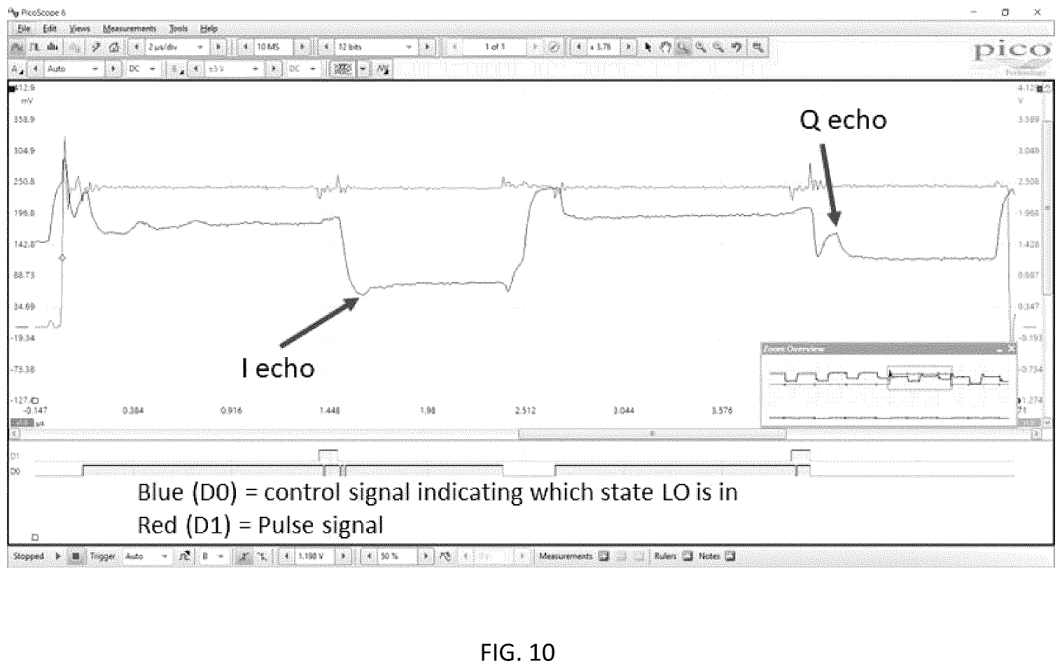

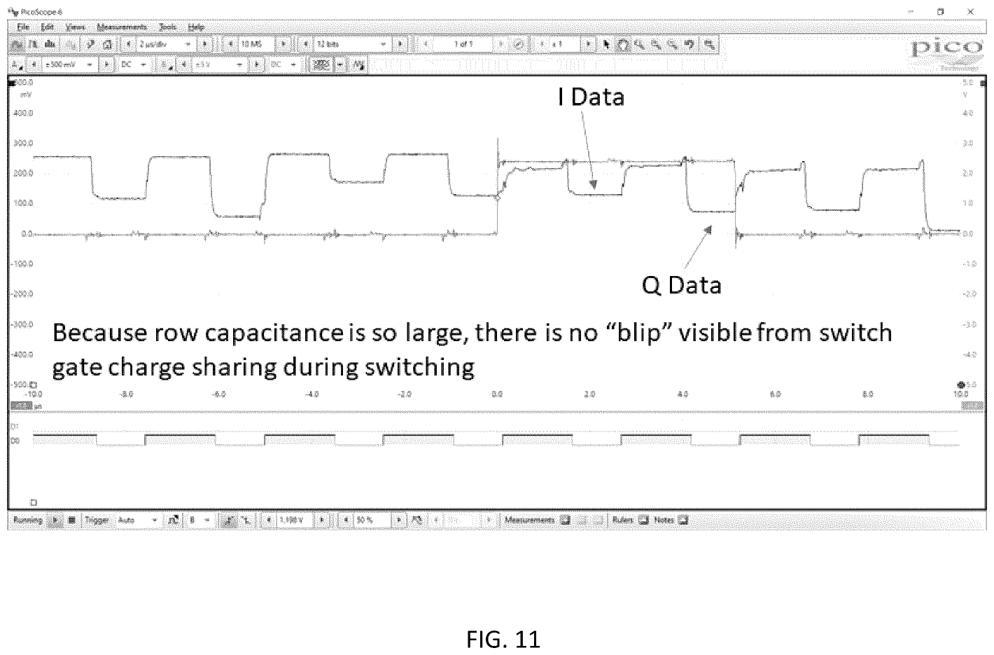

This quadrature demodulation scheme has been implemented on a 128×128 pixel chip. The time-multiplexed quadrature demodulation output for a single pixel in the array is shown in FIG. 10. When the sample and hold scheme is applied, where the pixel output select switch and the analog output line parasitics are used to form a sample and hold circuit, the time multiplexed IQ output is shown in FIG. 11.

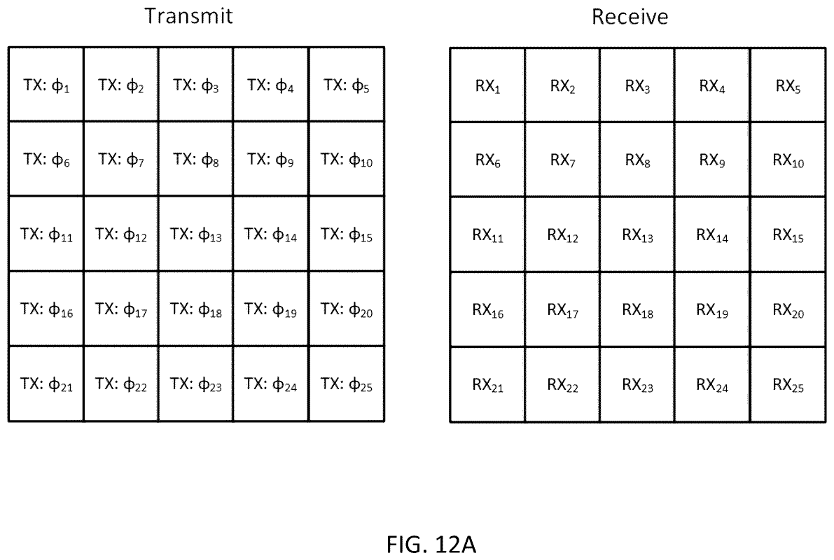

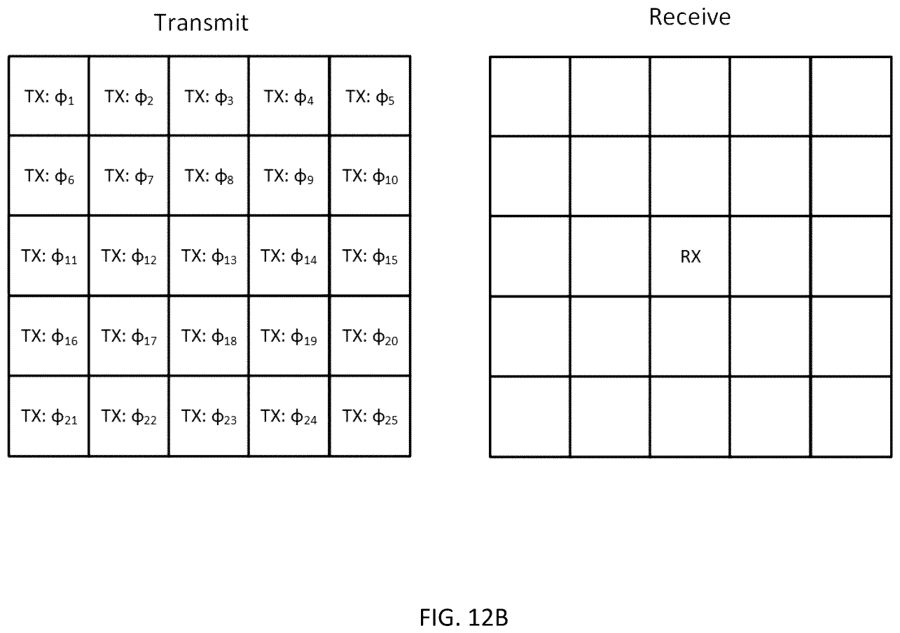

One method to capture higher resolution with an imaging array is to implement phased array imaging. However, incorporating a phase shifter into each pixel may not be feasible, particularly to achieve small pixel sizes and higher pixel densities, due to the area required to implement a phase shifter, at a given CMOS technology node. A conventional phased array scheme in which transmit beamforming is used is shown in FIG. 12A. In this scheme, each transmit transducer is actuated with the appropriate phase and all the transducer pixels on the array are used for receiving. If the beam is focused for maximum response near a single pixel, when scanning around that location, receiving on that single transducer pixel can be sufficient, as shown in FIG. 12B.

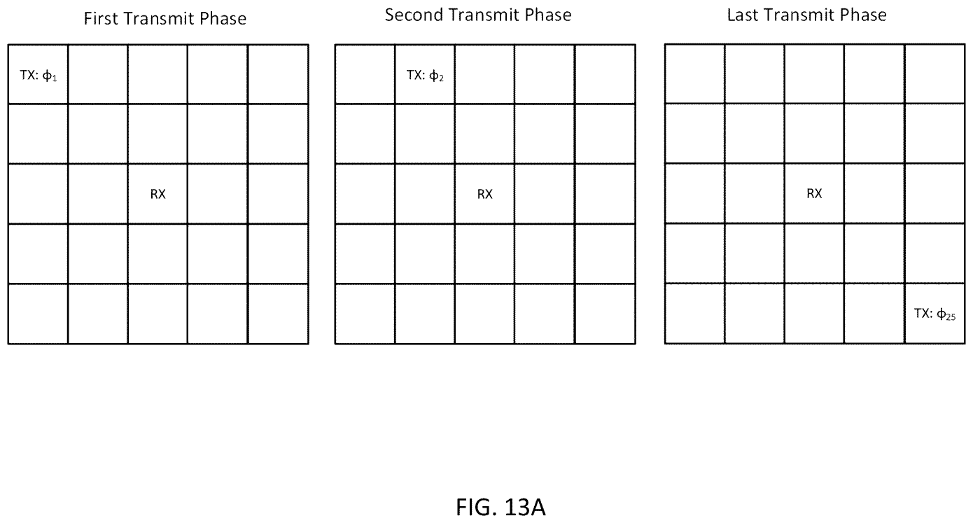

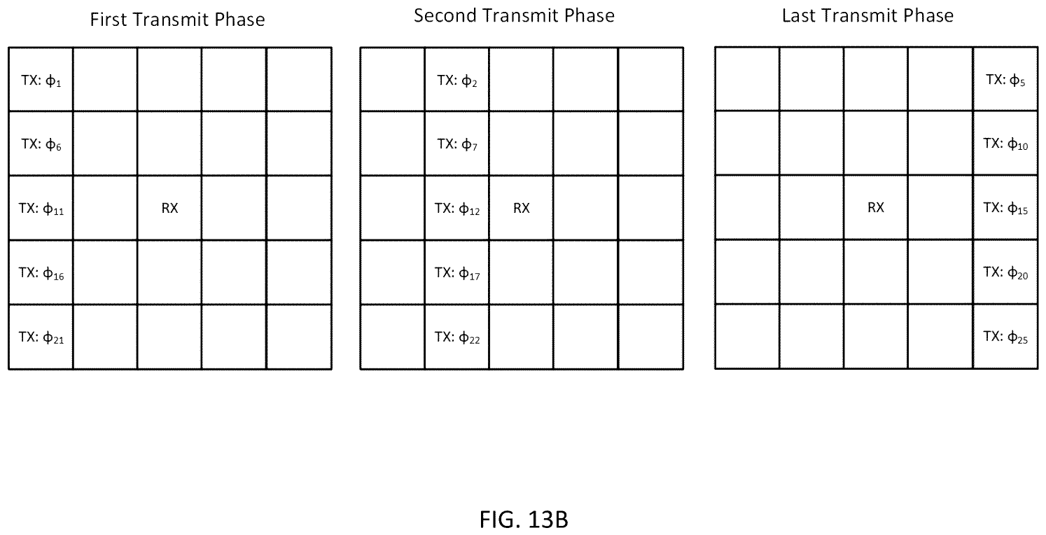

The downside with these schemes is that a phase shifter per pixel is required. We propose using the time-multiplexed transmit side phase shifting approach shown in FIGS. 13A-13B. Because the objects sensed by the sensor move slowly compared to the rate at which pixels are read from, a time-multiplexed scheme similar to the time-multiplexed IQ demodulation scheme described earlier can be used where the phased array image is acquired by phase shifting a single transmit pixel or group of transmit pixels and summing up received the signal on a receive transducer over multiple transmit cycles. This scheme is called “time-multiplexed phased array imaging”.

When only a single-phase shifter is available for the entire array, the scheme in FIG. 13A can be used. In this scheme, one pixel at a time is transmitted with the appropriate phase. Every time a pixel is transmitted from, the received echo on the receive transducer is measured and stored. Once all the pixels in a N by N array are transmitted from, the N² receive values are summed up. To increase the speed of the phased array imaging process, a phase shifter can be used per row in the array. This scheme, as shown in FIG. 13B, will allow an entire column of pixels to be transmitted from at a time with the appropriate phases. For a N by N phased array, N transmit cycles will be required and the received values on each transmit cycle will be stored and then summed up.

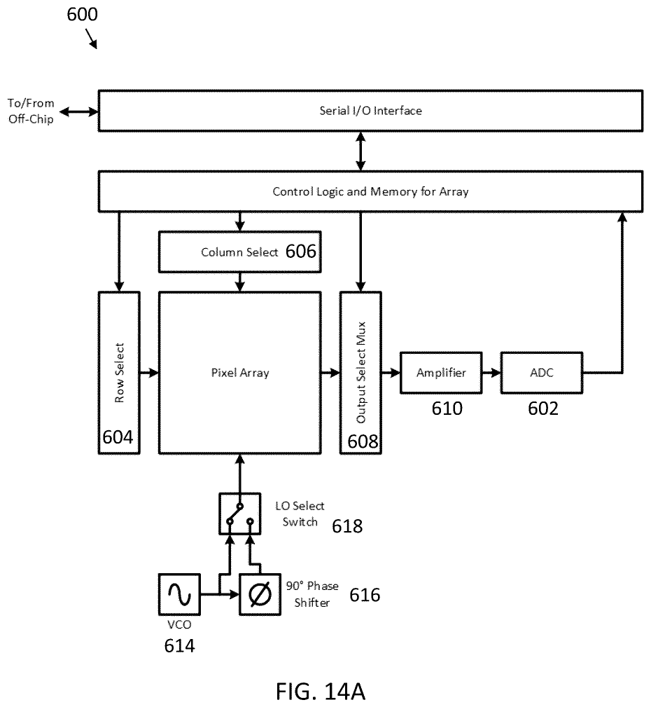

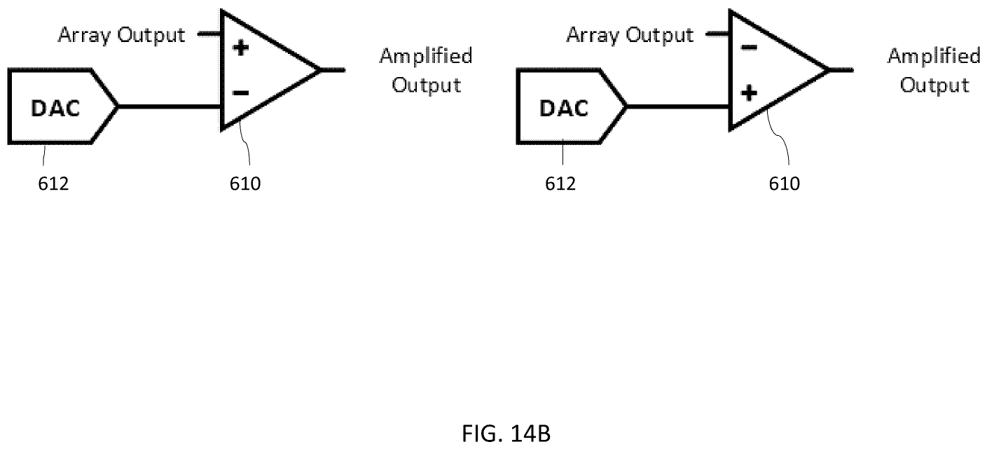

Turning now to FIGS. 14A and 14B, there is shown a simplified block diagram of array chip 600 using a single ADC 602 for the entire array and a schematic representation of the amplification of the difference between the pixel output voltage and a reference voltage from a DAC to increase the signal amplitude, respectively. FIG. 14A shows a possible implementation of the array with all circuits implemented on the same CMOS chip. In this configuration, only one ADC 602 is used for the entire array 600. The row and column can be selected by a decoder 604, 606 and designed so that a single pixel can be used for transmit and receive or to transmit on one pixel and receive on another pixel. The output from the receive pixel is selected out of the array using an analog multiplexer 608, a portion of which can be implemented using switches within each pixel. The output from this multiplexer 608 is then amplified (at amplifier 610).

One possible amplification scheme is shown in FIG. 14B, where the multiplexer output is subtracted against a DAC voltage 612 and amplified using a difference amplifier 610. The inputs to the amplifier 610 can be switched depending on the desired polarity of the signal. Specifically, the DAC voltage 612 can be set differently per pixel to account for pixel variations and can be set to different values to obtain better contrast when imaging different materials. The output from the amplification circuitry can then be fed into an ADC to be digitized.

Configuring the array chip and reading image and pixel data from the array is done through a serial interface. A VCO 614 (FIG. 14A) is included on the chip to generate the carrier frequency used for transmitting and demodulation. The clocking network used to distribute this LO (local oscillator) frequency to each pixel is implemented within the area of the array. For IQ demodulation, a 90 degrees phase shifter 616 is implemented on-chip and a switch 618 is used to select if a sine or cosine LO signal is used for demodulation. The frequency of the VCO 614 can be adjusted to image at different ultrasonic frequencies.

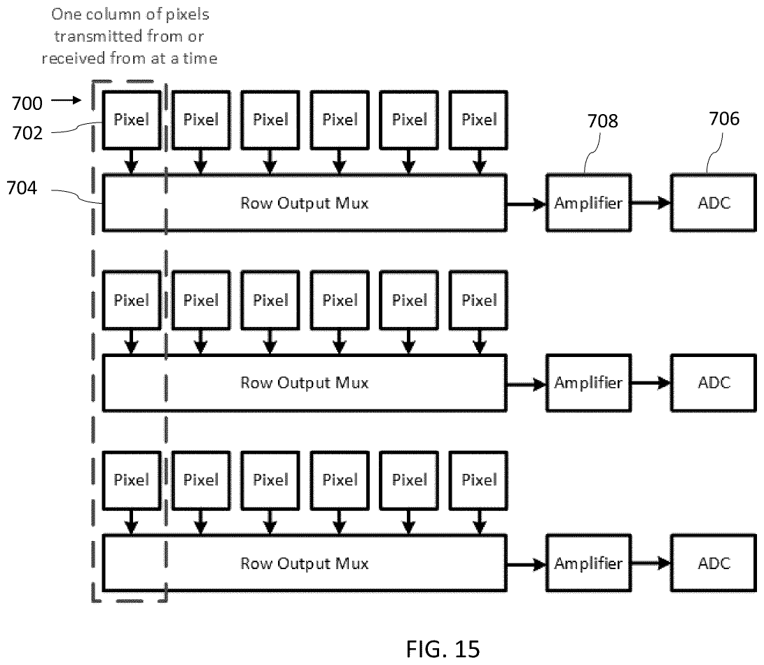

Referring now to FIG. 15, there is shown a simplified block diagram illustrating how the array can be implemented such that an entire column of pixels 700 is read from at a time. While using a single ADC 706 and receiving from a single pixel 702 at a time results in the simplest circuit, the frame rate is also limited because of the amount of time it takes to acquire from all of the pixels in the imager array when imaging one pixel at a time, particularly as the number of pixels in the array is increased to obtain higher resolution and/or larger images. To increase the frame rate, one method is to read from an entire column 700 at a time, as shown in FIG. 15, Transmit can be done from the same column of pixels for receiving or from a different column.

In addition to the transducer pixel transmit and receive circuits, the row contains a row output selection mux 704 (which can be implemented as part of the pixel), which selects the output of the pixel 702 in the row corresponding to the column 700 being received from. This output then goes into a row amplifier 708, the output of which goes to a row ADC 706, which digitizes the pixel output.

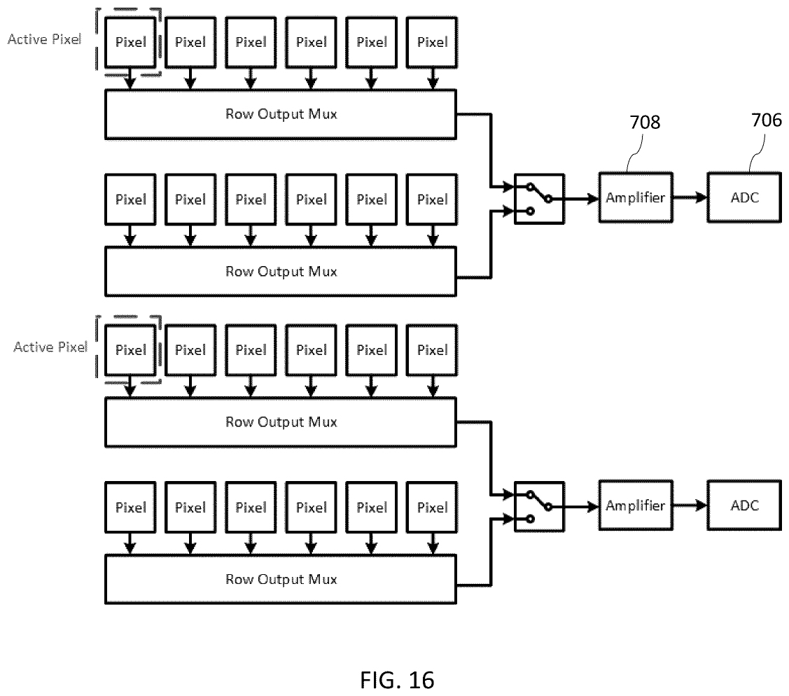

If the size of the ADC 706 and/or amplifier 708 is larger than the array pixel pitch, then instead of having an ADC 706 and an amplifier 708 per row, the ADC 706 and amplifier 708 can be shared for a group of rows, as shown in FIG. 16, where the amplifier 708 and ADC 706 are shared for every two rows.

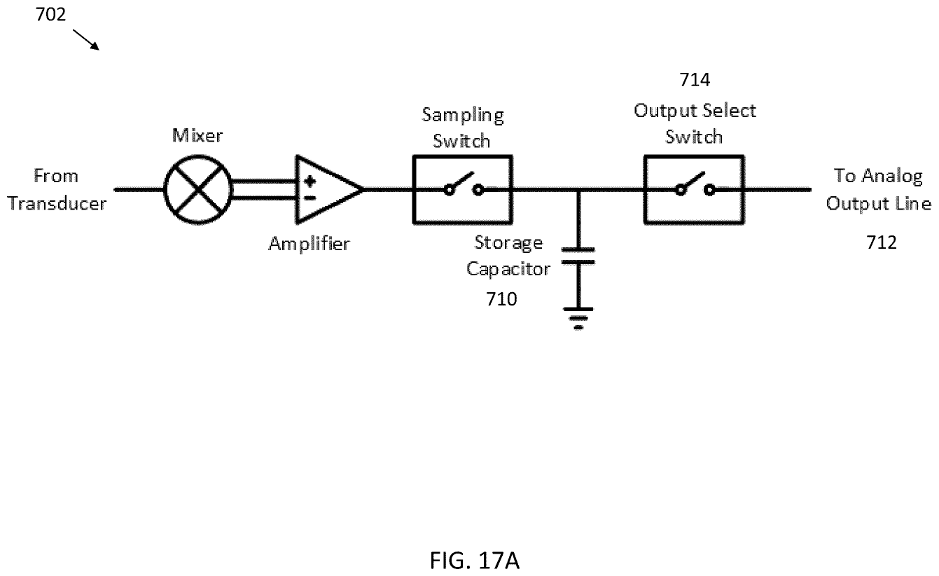

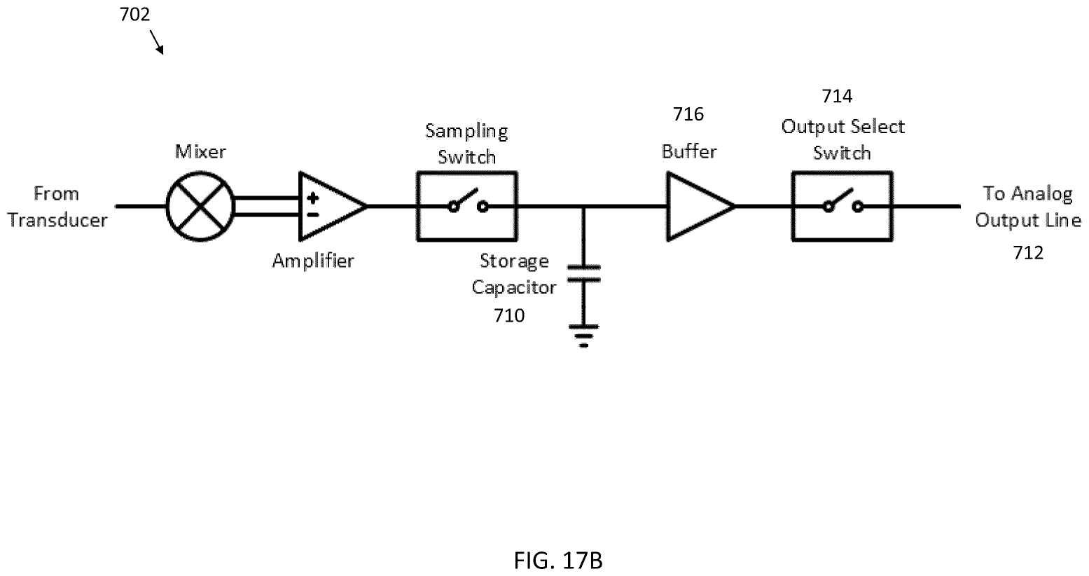

To allow for the sampling of shorter echoes, for scaling to large array sizes, or for sampling multiple pixels at a time, a storage capacitor 710 can be integrated within each pixel 702, as shown in EEGs. 1.7A-17B, This storage capacitor 710 allows for the acoustic echoes to be sampled and held within the pixel 702. The output of this capacitor 710 can be directly connected to the analog output line 712 within the row or array through a switch 714 (FIG. 17A) and/or through a buffer amplifier 716 (FIG. 17B).

To allow the array to achieve the fastest frame rates, it is desirable to put an ADC 706 within each pixel or per group of pixels 702, as shown in NG. 18A and 18B, This way the analog receive signal does not need to be distributed and selected out of the array and instead the received signal can be sent as a digital signal out of the array, reducing noise due to coupling from other circuits. In addition, this type of architecture can potentially allow for more than a single row of pixels to be received from at a time.

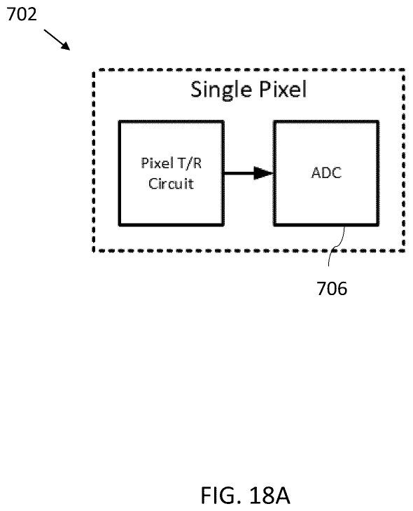

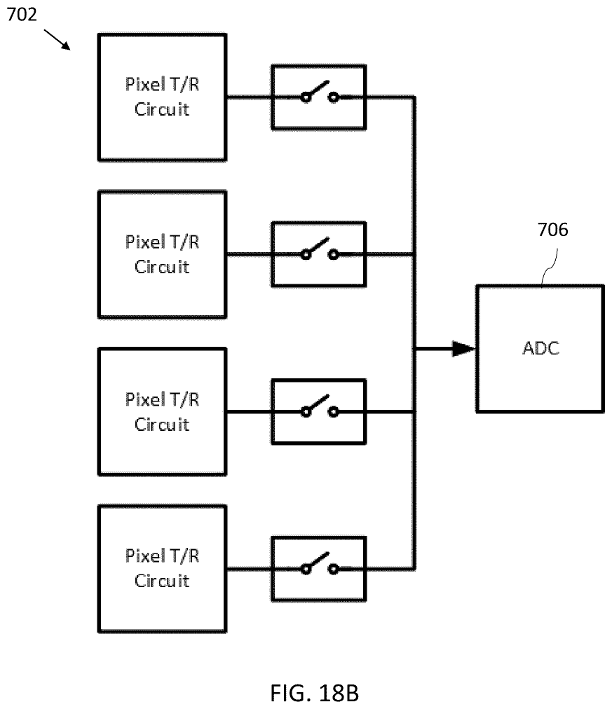

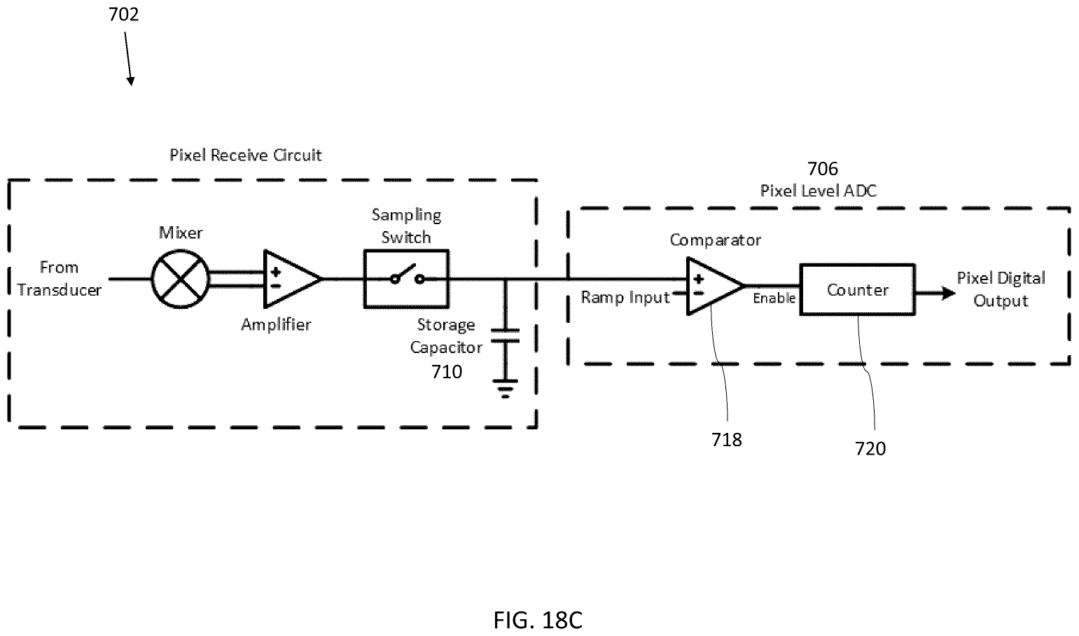

One possible implementation is to use a single-slope ADC topology, as shown in FIG. 18C, where the ADC 706 comprises of a single comparator 718 and a counter 720. A DAC, which does not need to be situated within the pixel 702, generates a ramp output that feeds into one of the comparator inputs 718. The counter 720 is stopped when the ramp voltage is equal to the voltage stored on the pixel capacitor 710. The output of the counter 720 is the output of the ADC 706. The resolution of the ADC 706 is determined by the number of bits in the counter 720.

Another possible approach to a phase array, is to use digital memory in each pixel to store whether to fire or not when the pulse line is activated. Many pixels can be programmed to activate, and hence can generate ultrasonic pulses from each of the pixels all at once. Similarly, many of the pixels can be programmed to be active during the receive cycle to share the charge generated from the selected pixels in this scheme each of the transmitted pulses are at the same phase, and the spatial location of the pixel can be used to form a phased array.

While embodiments of the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

1. An ultrasonic transducer pixel, comprising:
an ultrasonic transducer, connected to a transmit circuit and a receive circuit, transmit and receive circuits chosen by switches; and
a mixer of the receive circuit positioned as a first stage in the receive circuit;
a pixel select circuit comprising analog components and digital components;
a power supply conditioning circuitry,
wherein the receive circuit further comprises a baseband amplifier and an output select switch, the baseband amplifier between the mixer and the output select switch, and
wherein the output select switch is connected to wiring with a routing capacitance and the baseband amplifier, output select switch, and wiring are a filter.

2. The pixel of claim 1, wherein the mixer is a passive mixer.

3. (canceled)

4. (canceled)

5. The pixel of claim 1, wherein the output select switch and the wiring form a sample and hold scheme.

6. The pixel of claim 1, wherein the wiring is wiring parasitics.

7. The pixel of claim 1, in which one or more disable switches are incorporated into at least one of the transmit circuit and the receive circuits to power off the ultrasonic transducer pixel when it is not selected.

8. The pixel of claim 1, wherein the transmit circuit comprises of a pulse-gating circuit and a transmit driver, which are used to drive a single ultrasonic transducer through a transmit switch.

9. The pixel of claim 8, wherein the transmit circuit comprises a transmit switch and a receive switch to switch the transducer between the transmit circuit and the receive circuit, respectively.

10. The pixel of claim 1, further comprising GHz ultrasonic transducers positioned on top of the transmit circuit and the receive circuit.

11. The pixel of claim 10, wherein the GHz ultrasonic transducers, transmit circuit, and receive circuit are incorporated into a CMOS stack.

12. The pixel of claim 10, further comprising one or more auxiliary circuits positioned within an area of the pixel.

13. An imaging system, comprising:
a CMOS device comprising one or more CMOS circuits;
one or more piezoelectric transducers attached to the CMOS device;
one or more pixels connected to the one or more piezoelectric transducers, each pixel of the one or more pixels having a transmit circuit and a receive circuit;
wherein each receive circuit comprises a mixer first,
wherein a reference pixel is created by covering a silicon backside of the pixel with a layer to prevent contact with object being imaged, and
wherein a difference between received voltages of an imaging pixel output and a reference pixel output is amplified to achieve a higher sensitivity output.

14. The system of claim 13, further comprising a LO switching scheme connected to the transmit circuit and the receive circuit.

15. The system of claim 14, wherein the LO switching scheme comprises a VCO and a phase shifter that determines a phase of a local oscillator signal.

16. The system of claim 13, further comprising either a single transmit phase shifter for an array of the one or more pixels or a transmit phase shifter for a per row or a per column of the one or more pixels in an array of the one or more pixels, for phased array transmit beamforming.

17. The pixel of claim 1, wherein a sampling switch and a storage capacitor are implemented within the pixel to form a sample and hold circuit within the pixel.

18. The pixel of claim 17, further comprising a pixel level ADC, where an ADC is integrated within an area of a local group of pixels or within the area of a single pixel.

19. (canceled)

20. (canceled)
